(19) United States
(12) Patent Application Publication
(10) Pub. No.: US 2015/0062123 A1
(43) Pub. Date: Mar. 5, 2015

(54) AUGMENTED REALITY (AR) ANNOTATION COMPUTER SYSTEM AND COMPUTER-READABLE MEDIUM AND METHOD FOR CREATING AN ANNOTATED 3D GRAPHICS MODEL

(71) Applicant: NGRAIN (Canada) Corporation, Vancouver (CA)

(72) Inventor: Billy Kai Cheong Yuen, Richmond (CA)

(73) Assignee: NGRAIN (Canada) Corporation, Vancouver (CA)

(21) Appl. No.: 14/015,736

(22) Filed: Aug. 30, 2013

(51) Int. Cl. G06T 17/00; G06T 19/00

(52) U.S. Cl. CPC G06T 17/00; G06T 19/006
USPC 345/420

(57) ABSTRACT

A system, computer-readable medium, and method for creating an annotated 3D model are provided. First, 3D coordinates of at least two real alignment points for/on a real object are acquired. Second, 3D virtual space, in which a 3D model exists, is merged with 3D real space, in which the real object exists, to thereby align the 3D model with the real object, by matching at least two virtual alignment points of the 3D model with the at least two real alignment points of the real object. Third, an annotated 2D image/video of the real object is prepared and projected to surfaces of the 3D model by translating a 3D coordinate and orientation of the visual sensor in the 3D real space used to acquire the annotated 2D image/video to a 3D coordinate and orientation of the visual sensor in the 3D virtual space, to thereby create an annotated 3D model.

### BACKGROUND

1. Technical Field

The present application is directed to augmented reality and, more specifically, to a system, computer-readable medium, and method for adding an annotation to a 3D graphics model in augmented reality.

2. Description of the Related Art

Augmented reality (AR) is a live view of a physical, real-world environment whose elements are augmented by computer-generated graphics and text data. For example, a mobile AR solution available from NGRAIN (Canada) Corp. of Vancouver, Canada permits an operator of a mobile tablet computer (e.g., iPad® or Android®-based tablets) to view a real object (e.g., an airplane) whose elements (e.g., tail wings) are augmented by computer-generated graphics and text data, such as outlines or highlights superimposed on the tail wings or a text window appearing to present information about the tail wings (e.g., how to inspect, repair, or replace the tail wings for maintenance personnel). Some details of an example AR solution are described in “Augmented Reality on Tablets in Support of MRO Performance”, A. Woo, B. Yuen, T. Hayes, C. Byers, E. Fiume, Interservice/Industry Training, Simulation & Education (I/ITSEC), December 2012.

3D graphics models are widely used to represent various real objects, for example, for the purpose of designing and maintaining the real objects. One important requirement for proper maintenance of a real object is to keep an accurate maintenance log that records, for example, what damage or defect was discovered, on which part or component, as well as what repair was subsequently made. Currently, there are no easy methods for keeping accurate maintenance logs for some of more complicated structures, machinery, etc., such as aircraft. Some known methods involve an inspector manually noting the type (visual characteristics, such as shape, texture, etc.) and location of a discovered damage and entering them as an annotation to the corresponding 3D model, which is a cumbersome process. Also, these methods often require the inspector to make a physical contact with the damaged area, which is not desirable in some cases. Still further, the known methods are not ideal for accurately recording both the type (visual characteristics) and precise location of the damage found. For example, when an inspector uses a camera to record the type and location of a discovered damage, zooming in to capture the damage type would lead to loss of orientation and context information needed to locate the damage relative to the real object, and zooming out to capture the orientation and context information would lead to loss of information on the type of the damage.

A need exists for a system, computer-readable medium and method, which permit, for example, an inspector of a real object to keep a maintenance log in association with a 3D model of the real object in an easy, streamlined, and accurate manner.

### BRIEF SUMMARY

According to an aspect of the present invention, an augmented reality (AR) annotation computer system is provided. The system includes a processor, and a storage device loaded with a 3D model of a real object and accessible by the processor, wherein the 3D model is associated with at least two virtual alignment points. The system further includes a visual sensor (e.g., a camera) connected to a position/orientation tracker, wherein the visual sensor is provided to acquire an image/video of the real object in 3D real space while the position/orientation tracker acquires a 3D coordinate and orientation of the visual sensor used to acquire the image/video. The position/orientation tracker includes a position tracker and an orientation tracker, which may be integrally formed together or may be separately provided. The system still further includes a display connected to an input device. The display and input device are configured to allow an operator to add an annotation to the image/video of the real object acquired by the visual sensor, to thereby create an annotated 2D image/video.

The storage device is further loaded with an operating system and a 3D model annotation program, wherein the 3D model annotation program is configured to cause the processor to perform the steps including generally four steps. First, 3D coordinates of at least two real alignment points for/on the real object are received. The real alignment points are acquired by the position tracker of the system. Second, 3D virtual space, in which the 3D model exists, is merged with the 3D real space, in which the real object exists, to thereby align the 3D model with the real object, by matching the at least two virtual alignment points of the 3D model with the at least two real alignment points of the real object. Third, the annotated 2D image/video of the real object, generated by the use of the display and the input device, is projected to surfaces of the 3D model by translating the 3D coordinate and orientation of the visual sensor in the 3D real space used to acquire the 2D image/video to a 3D coordinate and orientation of the visual sensor in the 3D virtual space, to thereby create an annotated 3D model. Fourth, the annotated 3D model is stored in the storage device.

According to another aspect of the present invention, a computer-readable tangible medium including computer-executable instructions of a 3D model annotation program is provided, wherein the 3D model annotation program, when executed by a processor coupled to a storage device loaded with a 3D model of a real object, causes the processor to perform generally four steps. First, 3D coordinates of at least two real alignment points for/on the real object are received. Second, 3D virtual space, in which the 3D model exists, is merged with the 3D real space, in which the real object exists, to thereby align the 3D model with the real object, by matching at least two virtual alignment points of the 3D model with the at least two real alignment points of the real object. Third, an annotated 2D image/video of the real object is projected to surfaces of the 3D model by translating a 3D coordinate and orientation of the visual sensor in the 3D real space used to acquire the annotated 2D image/video to a 3D coordinate and orientation of the visual sensor in the 3D virtual space, to thereby create an annotated 3D model. Fourth, the annotated 3D model is stored in the storage device.

According to yet another aspect of the present invention, a method of creating an annotated 3D model of a real object is provided. The method includes generally seven steps below:

(i) loading a 3D model of the real object to a processor-accessible storage device, wherein the 3D model is associated with at least two virtual alignment points;

(ii) acquiring 3D coordinates of at least two real alignment points for/on the real object in 3D real space using a position tracker;

(iii) acquiring an image/video of the real object in the 3D real space using a visual sensor and acquiring a 3D coordinate and orientation of a visual sensor used to acquire the image/video in the 3D real space using the position/orientation tracker;

(iv) adding an annotation to the image/video of the real object, to thereby create an annotated 2D image/video;

(v) using a processor to merge 3D virtual space, in which the 3D model exists, with the 3D real space, in which the real object exists, to thereby align the 3D model with the real object, by matching the at least two virtual alignment points of the 3D model with the at least two real alignment points of the real object;

(vi) using the processor to project the annotated image/video of the real object to surfaces of the 3D model by translating the 3D coordinate and orientation of the visual sensor in the 3D real space used to acquire the annotated 2D image/video to a 3D coordinate and orientation of the visual sensor in the 3D virtual space, to thereby create an annotated 3D mode; and

(vii) storing the annotated 3D model in the storage device.

Therefore, various embodiments of the present invention provide a system, computer-readable medium, and method for creating an annotated 3D model, in which an operator's annotation added to a 2D image/video of a real object is automatically projected onto surfaces of the 3D model of the real object and recorded as an annotated 3D model. Thus, the process of keeping a maintenance log of a real object can be replaced by the process of creating and updating the annotated 3D model for the real object, which is streamlined and easy to implement as well as highly accurate and precise as a record keeping process.

### BRIEF DESCRIPTION OF THE SEVERAL VIEWS OF THE DRAWINGS

FIG. 1 is a diagram showing an augmented reality (AR) annotation computer system, which is suitable for online (real time) mobile application of the present invention to create an annotated 3D model, according to one embodiment.

FIG. 2 is a block diagram illustrating example components included in the AR annotation computer system of FIG. 1.

FIG. 3 is a flowchart illustrating an example process of creating an annotated 3D model in the online (real time) mobile application of the present invention.

FIG. 4 is a diagram that illustrates an example process of acquiring 3D coordinates of at least two real alignment points for/on a real object in 3D real space using a position tracker, and merging 3D virtual space, in which a 3D model associated with at least two virtual alignment points exits, with the 3D real space, in which the real object exists, by matching the real and virtual alignment points.

FIG. 5 is a diagram that illustrates a sample process of projecting an annotated 2D image/video of a real object to surfaces of a 3D model by translating a 3D coordinate and orientation of a visual sensor in 3D real space used to acquire the 2D image/video to a 3D coordinate and orientation of the visual sensor in 3D virtual space, to thereby create an annotated 3D model.

FIG. 6 is a diagram showing an AR annotation computer system, which is suitable for offline (off time) application of the present invention to create an annotated 3D model, according to one embodiment.

FIG. 7 is a block diagram illustrating example components included in the AR annotation computer system of FIG. 6.

FIG. 8 is a flowchart illustrating an example process of creating an annotated 3D model in the offline (off time) application of the present invention.

### DETAILED DESCRIPTION

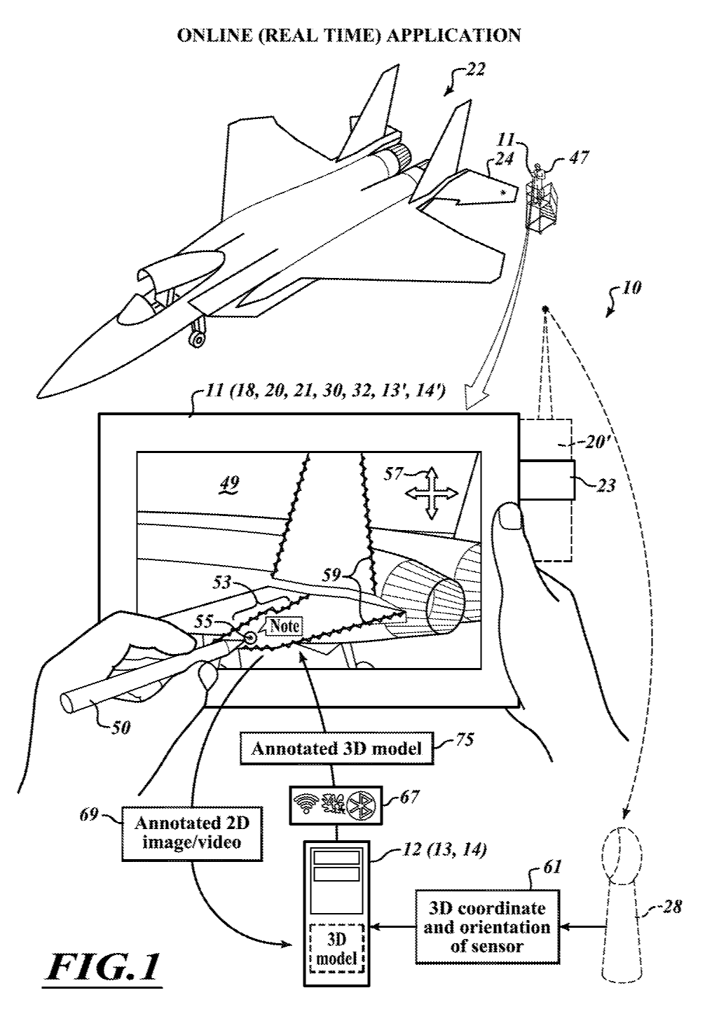

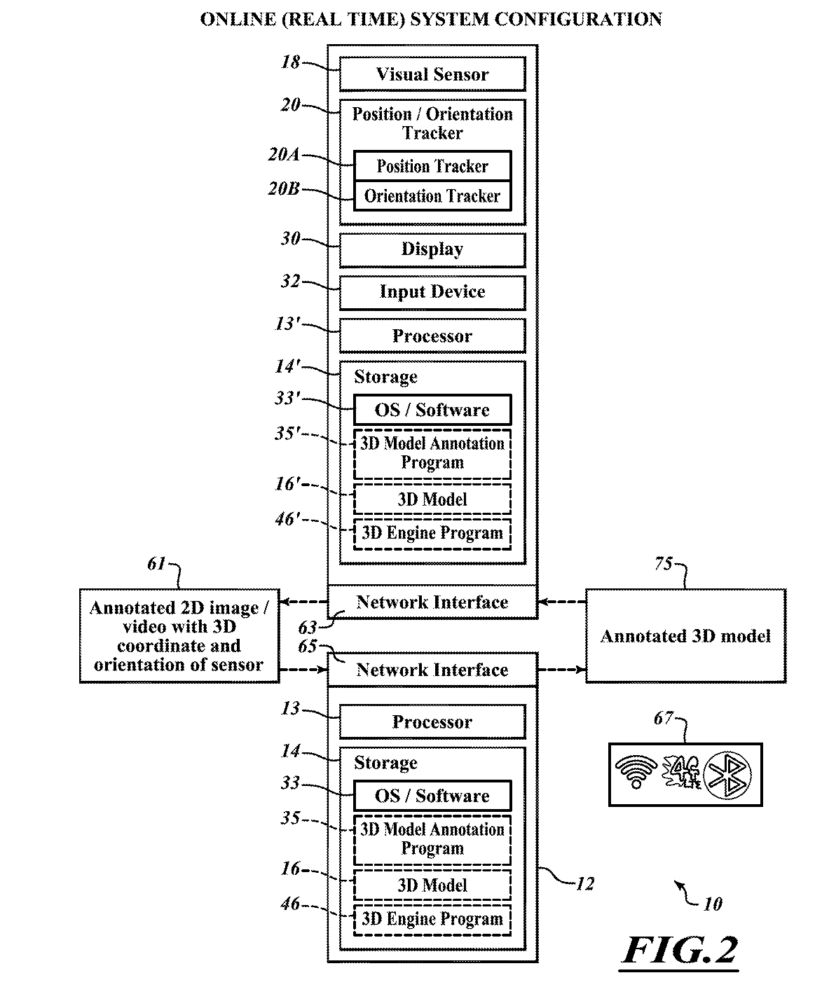

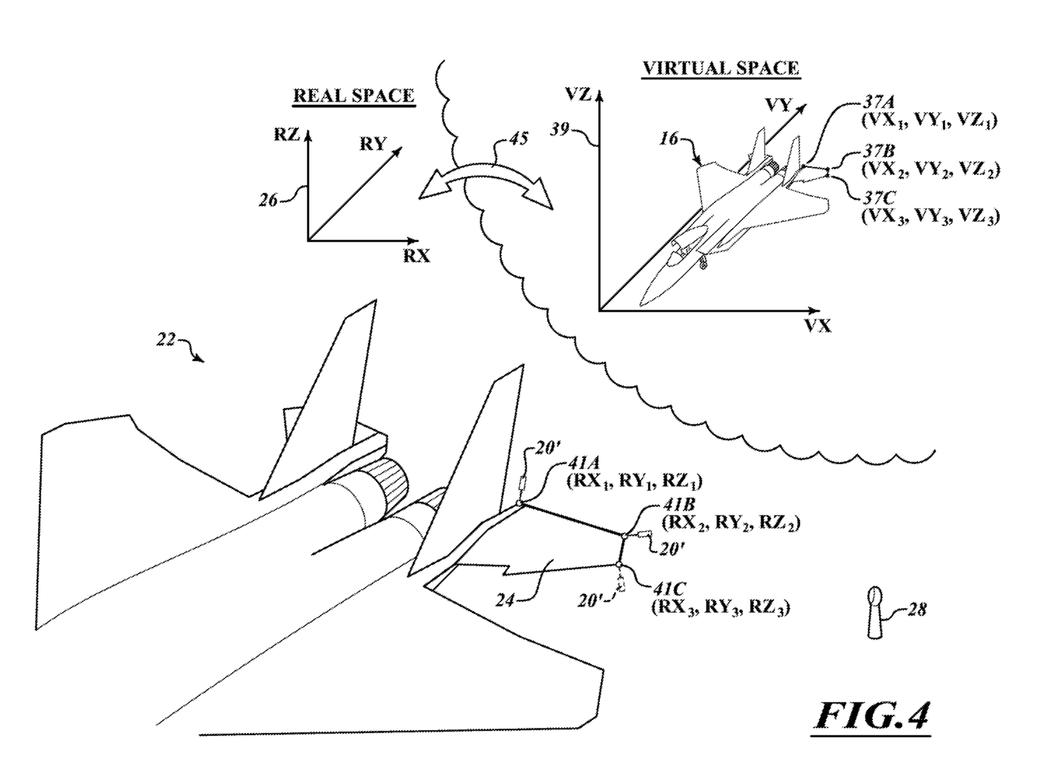

FIG. 1 is a diagram showing an augmented reality (AR) computer system 10, which is suitable for online (real time) mobile application of the present invention to create an annotated 3D model, according to one embodiment. In additional reference to FIG. 2, which is a block diagram illustrating example components included in the AR annotation computer system 10 of FIG. 1, the AR annotation computer system 10 includes a processor 13, and a storage device 14 accessible by the processor 13 and loaded with a 3D model 16 of a real object. As more fully described below in reference to FIG. 4, the 3D model is associated with at least two virtual alignment points 37A, 37B, and 37C, which will be used to merge the 3D model with its corresponding real object.

Any suitable processor capable of performing computation and calculation needed to manipulate 2D images and 3D models, as will be described below, can be used as the processor 13. For typical applications, a communication server, as illustrated in FIG. 1, or a processor included in a standard notebook computer is sufficient for use as the processor 13. Further, a processor 13′ included in a tablet computer 11, if equipped with sufficient processing power, may be used as the processor 13. Still further, the processor 13 may be comprised of two or more processors, such as the communication server/notebook processor 13 and the tablet processor 13′, which are communicable with each other, to carry out the necessary computation and calculation in a distributed manner.

The 3D model 16 may be any mathematical representation of a three-dimensional object, such as a surface-based 3D model wherein surfaces of the object are defined by polygon meshes, by curves, or by points (i.e., a point cloud), or a volume-based 3D model wherein exterior surfaces of the object as well as its internal structure are defined by voxels, which are pixels with a third dimension (e.g., cubes).

The AR annotation computer system 10 also includes a visual sensor 18 connected to a position/orientation tracker 20. The visual sensor 18 may be any sensing device capable of obtaining image and/or video data, including a camera, a camcorder, a CMOS sensor, a charge-coupled device (CCD), and other devices operable to convert an optical or magnetic signal into electronic image/video data such as an IR camera, a thermographic camera, a UV camera, an X-ray camera, and an MRI imaging device. In the online (real time) mobile application of the AR annotation computer system 10 as shown in FIG. 1, the visual sensor 18 may be provided by a camera included in the tablet computer 11. The visual sensor 18 is used to acquire an image/video of the real object 22, such as an airplane as shown in FIG. 1. As will be apparent to those skilled in the art, the real object 22 may be any object of interest, for which a 3D model can be created and to which an annotation is desirably added. FIG. 1 shows an operator 47, such as an inspector, taking an image/video of a tail wing 24 of the airplane object 22 using the visual sensor 18 (e.g., camera) of the tablet computer 11. The position/orientation tracker 20 connected to the visual sensor 18 includes a position tracker 20A and an orientation tracker 20B, which may be integrally formed together or may be separately provided. Thus, the position/orientation tracker 20 may take various forms and configurations. The position/orientation tracker 20 is configured to determine its 3D coordinate position, (RXn, RYn, RZn), as well as its three-axis orientation as in a vector, within a real space coordinate system 26 as shown in FIG. 4. An example of the position/orientation tracker 20, which includes a position tracker and an orientation tracker integrally formed with each other, is a laser probe 20′, which is part of a laser tracking system including the laser probe 20′ and a laser observer 28, such as those available from Hexagon Metrology Inc., Creaform Inc, Faro Technologies, Inc. and Nikon Corp. Briefly, the laser observer 28 sends a laser beam to the laser probe 20′ held in contact with the object of interest, and analyzes light reflected off the laser probe 20′ and returned to the laser observer 28 to determine 3D coordinates and orientation of the tip of the laser probe 20′ in a given coordinate system.

The laser probe 20′ is an example of an integral position/orientation tracker 20 operable to track both its position and coordinate in a given coordinate system. In other embodiments, the position/orientation tracker 20 may be comprised of a position tracker 20A operable to track its position and a separate orientation tracker 20B operable to track its orientation in a given 3D coordinate system. Examples of a position tracker, which may or may not include an integral function to additionally track orientation, include other indoor positioning devices (sometimes called “indoor GPS” devices) with sufficient accuracy for the purpose of the present invention. These indoor positioning devices may include a wireless communication device (e.g., a Wi-Fi device) to be placed amongst three communication nodes (e.g., Wi-Fi routers) such that the device's position can be calculated by using the signal strengths detected at or from these nodes based on triangulation. Some of these indoor positioning devices may be at least partially based on, or augmented by, the GPS system based on satellite signals. Any positioning device operable to track its position in a given coordinate system may be used as the position tracker 20A.

Examples of an orientation tracker 20B, which may be combined or coupled with a position tracker 20A to together form a position/orientation tracker 20, include a three-axis accelerometer, a two-axis accelerometer combined with additional sensor(s) such as a solid-state compass, a gyroscope, etc. For example, an accelerometer that is typically included in the tablet computer 11 to sense orientation of the tablet computer 11, such as its display 30, may be used as the orientation tracker 20B in some embodiments.

In the illustrated embodiment of FIG. 1, a laser tracking system including the laser observer 28 and the laser probe 20′ is used, of which the laser probe 20′ is connected to the visual sensor 18 of the tablet computer 11 as the position/orientation tracker 20. In the illustrated embodiment, a bracket 23 is used to mount the laser probe 20′ in a fixed positional relationship relative to the visual sensor 18 of the tablet computer 11, such that the position and orientation of the visual sensor 18 can be calculated based on the determined position and orientation of the laser probe 20′. For example, the orientation tracker 20B of the position/orientation tracker 20 may be connected in a fixed orientation relationship relative to a principal ray axis of the visual sensor 18, such that the orientation of the visual sensor 18 can be calculated based on the determined orientation of the orientation tracker 20B.

The AR annotation computer system 10 also includes a display 30 connected to an input device 32. The display 30 may be, for example, an LCD, and the input device 32 may be, for example, a pen sensor, touch sensor (touch pad), keyboard, mouse, trackball, joystick, glove controller, gesture sensor, motion sensor, etc. In the illustrated embodiment of FIG. 1, the display 30 is provided as an LCD of the tablet computer 11, and the input device 32 is provided as a pen/touch sensor of the tablet computer 11 that is laid over (or under) the display 30. As will be more fully described below, the display 30 and the input device 32 are used by an operator to add an annotation to the 2D image/video of a real object acquired by the visual sensor 18. For example, when the 2D image/video of a real object includes a damaged area found in the real object, an operator may add an annotation to the 2D image/video on or next to the damaged area, such as an outline that traces the damaged area or a text note regarding the damaged area.

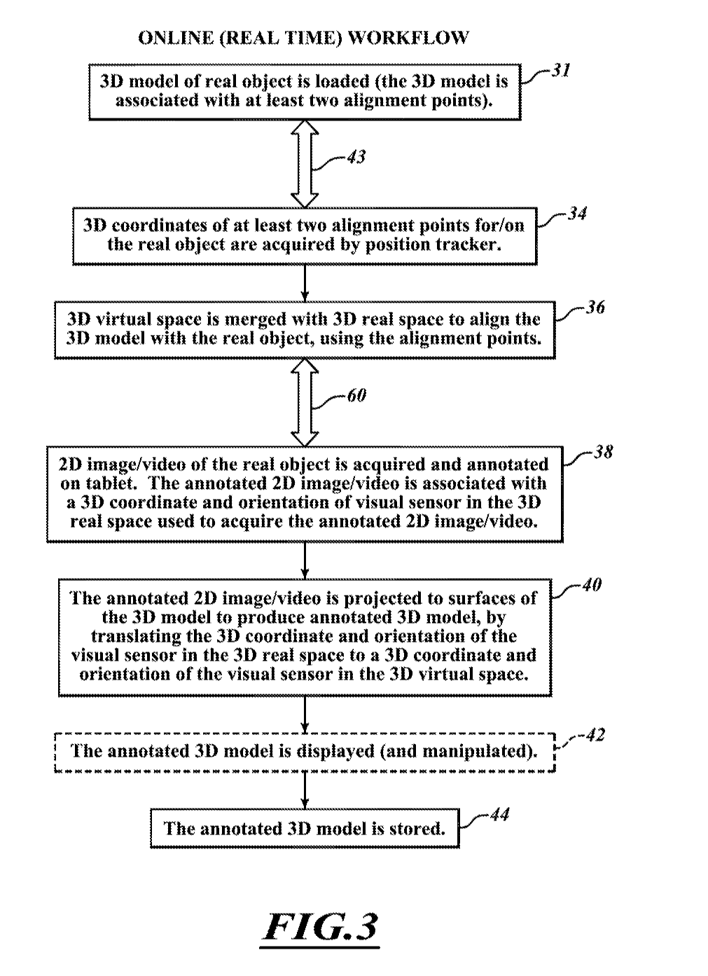

Referring additionally to FIG. 3, an example process of creating an annotated 3D model in the online (real time) mobile application using the AR annotation computer system 10 of FIG. 1 is now described.

In step 31, the 3D model 16 of a real object may be loaded to the storage device 14 of the server 12 and/or to the storage device 14′ of the tablet computer 11, as long as the 3D model 16 is accessible by the processor 13 of the server 12 and/or the processor 13′ of the tablet computer 11 used to control the process of creating an annotated 3D model. The storage device 14/14′ is further loaded with an operating system (OS) 33/33′ for controlling the operation of the processor 13/13′ and any other software, as well as a 3D model annotation program 35/35′ including computer-executable instructions to implement various steps of creating an annotated 3D model. The storage device 14/14′ may still further include a 3D engine program 46 configured to control various 3D model related functions and routines, such as creating the 3D model 16, rendering the 3D model 16 on the display 30, and other manipulation of the 3D model 16.

Referring additionally to FIG. 4, the 3D model 16 is associated with at least two virtual alignment points 37A (VX1, VY1, VZ1), 37B (VX2, VY2, VZ2), and 37C (VX3, VY3, VZ3), which will be used to merge the 3D virtual space 39, in which the 3D model 16 exists, with the 3D real space 26, in which the real object 22 exists. Typically, the orientation of the real object 22 along one of three coordinate axes is fixed and, therefore, two virtual alignment points would be sufficient to define a three-axis orientation of the real object 22 in those cases. For example, a real object such as an airplane is always placed right side up and, therefore, its orientation along one axis is fixed. In these cases, two virtual alignment points, such as 37A and 37B, would be sufficient for aligning the 3D model 16 with its real object 22, both of which are assumed to be placed right side up. Even in those cases, however, using a greater number of virtual alignment points may be preferable in order to increase the accuracy of alignment (or registration) of the 3D virtual space 39 with the 3D real space 26. Therefore, in the illustrated embodiment of FIG. 4, three virtual alignment points 37A, 37B, and 37C are associated with the tail wing 24 of the airplane 3D model 16. In step 34 of FIG. 3, 3D coordinates of at least two real alignment points for/on the real object 22 are acquired using the position tracker 20A (of the position/orientation tracker 20). For example, referring additionally to FIG. 4, the position tracker 20A in the form of a laser probe 20′ may be used to contact each of the real alignment points 41A (RX1, RY1, RZ1), 41B (RX2, RY2, RZ2), and 41C (RX3, RY3, RZ3) of the real object 22, which respectively correspond to the virtual alignment points 37A, 37B and 37C of the 3D model 16. In FIG. 4, the laser probe 20′ in contact with the real alignment point 41C is shown in dashed lines because, if the 3D model 16 is associated with only two virtual alignment points such as 37A and 37B, then it is not necessary to obtain a 3D coordinate of the third real alignment point 41C.

The observer 28 of the laser tracking system including the laser probe 20′ is operable to determine the 3D coordinates of these real alignment points 41A, 41B, and 41C based on signals returned from the laser probe 20′. To facilitate the process of acquiring the 3D coordinates of the real alignment points, for example, when an operator is using the tablet computer 11 on-site, the tablet computer 11 may provide visual or textual instructions to the operator to indicate where the real alignment points 41A, 41B, and 41C are located on or in association with the real object 22.

For the purpose of precise registration and merging between the 3D virtual space 39 and the 3D real space 26, the alignment points should be set at positions that the operator can readily locate, such as at a corner, a tip, or any sharply-bent portion. While the real alignment points 41A, 41B, and 41C are located on the real object 22 in the illustrated embodiment, the alignment points need not be physically located on the real object 22 and need only be set in a fixed positional relationship relative to the real object 22. For example, when the real object 22 is placed on a docking platform or some other support structure, and the relative position and orientation of the real object 22 are fixed with respect to the docking platform, the real alignment points may be placed on the docking platform. In these cases, the corresponding virtual alignment points in the 3D virtual space 39 are also placed relative to the 3D model 16, according to the same fixed positional relationship as defined for the real alignment points relative to the real object 22.

While step 31 of loading the 3D model 16 appears above step 34 of acquiring 3D coordinates of the real alignment points for/on the real object 22 in FIG. 3, the order of these steps 31 and 34 may be switched, or these steps 31 and 34 may be performed simultaneously, as indicated by an arrow 43.

In step 36, the processor 13/13′ merges the 3D virtual space 39, in which the 3D model 16 exists, with the 3D real space 26, in which the real object 22 exists, by matching the at least two virtual alignment points 37A, 37B, and 37C of the 3D model 16 with the at least two real alignment points 41A, 41B, and 41C of the real object 22. The merging process is schematically illustrated in FIG. 4, in particular by an arrow 45 that represents registration of the virtual alignment points 37 and the real alignment points 41 to thereby merge the 3D virtual space 39 and the 3D real space 26.

In step 38, the operator 47 on-site acquires a 2D image/video 49 of the real object 22 using the visual sensor 18, and the acquired 2D image/video 49 is displayed on the display 30 in real time, as shown in FIG. 1. Both the visual sensor 18 and the display 30 are part of the tablet computer 11 in the illustrated embodiment. Using the input device 32, which is the pen/touch sensor of the tablet computer 11 including a pen 50 in this case, the operator 47 adds an annotation 53 to the 2D image/video 49. As used herein, the 2D image/video 49 means a 2D image or a frame of a 2D video acquired by the visual sensor 18.

In the illustrated example, the operator 47 has traced the outline of a damage 55 found in the 2D image/video 49, added a circle around the damage 55, and further added a note including textual information about the damage 55. With a zoomable (resizable) type of the display 30, indicated by a 4-way arrow 57 on the display 30 of the tablet computer 11, the operator 47 may readily zoom in (enlarge) the image/video portion including the damage 55 so as to clearly observe the damage 55 and to add a precise annotation 53 to the damage 55. Various types of information and data may be added as an annotation, including an audio file including the operator/inspector's voice recording commenting on the damage found, or application of any pre-defined marking, code, etc.

In FIG. 1, the outline of the real object 22 shown on the display 30 is emphasized, with zigzag lines 59 in this example, to visually indicate that the 3D real space 26, in which the real object 22 exists, has now merged with the 3D virtual space 39, in which the 3D model 16 exists, i.e., step 36 has been completed. However, it is not critical that step 36 occurs before step 38, and some or all of the processes in step 38 may occur before step 36 or simultaneously with step 36, as indicated by a two-way arrow 60. For example, the operator 47 may acquire a 2D image/video of the real object 22 before, or simultaneously with, the step of merging the 3D virtual space 39 with the 3D real space 26. As a further example, the operator 47 may add an annotation to the 2D image/video 49 before, or simultaneously with, the step of merging the 3D virtual space with the 3D real space. If the merging step has not been completed, the operator 47 does not see the zigzag lines 59 laid over the 2D image/video of the real object 22.

Still referring to step 38, when the operator 47 acquires a 2D image/video of the real object 22, a 3D coordinate and orientation of the visual sensor 18 used to acquire that 2D image/video are also recorded in association with the 2D image/video. In the illustrated embodiment, the position/orientation tracker 20 connected to the visual sensor 18 of the tablet computer 11 is used to acquire the 3D coordinate and orientation of the visual sensor 18, respectively. In the AR annotation computer system 10 suitable for online (real time) mobile application of the present invention, the 3D coordinate and orientation of the visual sensor 18 may be sent to the processor 13/13′ in real time, while the annotated 2D image/video is also sent to the processor 13/13′, as shown in a box 61 of FIG. 2. To that end, when the tablet computer 11 is used that communicates with the external server 12, the tablet computer 11 includes a network interface 63 and the server 12 includes a network interface 65 for carrying out selected wireless communications between the two computers pursuant to any suitable communications standards such as the Wi-Fi standards, 3GPP 3G/4G/LTE standards, and the Bluetooth® standards, as shown in a box 67. When the laser probe 20′ as part of the laser tracking system including the observer 28 is used as the position/orientation tracker 20, as shown in FIG. 1, the annotated 2D image/video 69 is received from the visual sensor 18 of the tablet computer 11, while the 3D coordinate and orientation 61 of the visual sensor 18 is received from the laser observer 28 in communication with the laser probe 20′ connected to the tablet computer 11, also pursuant to any suitable communications standards 67. In any event, the processor 13/13′ receives both the annotated 2D image/video 69 and the position and orientation 61 of the visual sensor 18 used to acquire the annotated 2D image/video, in real time, in the online (real time) application of the AR annotation computer system 10.

In some embodiments, the 3D coordinate and orientation of the visual sensor 18 may be associated with the 2D image/video by the processor 13′ of the tablet computer 11 and are sent in association with each other to the separate server 12. In other embodiments, each of the 2D image/video, the 3D coordinate of the visual sensor 18, and the orientation of the visual sensor 18 is time-stamped and sent to the server 12, and the server 12 uses these time stamps to synchronize the 2D image/video with its associated 3D coordinate and orientation of the visual sensor 18.

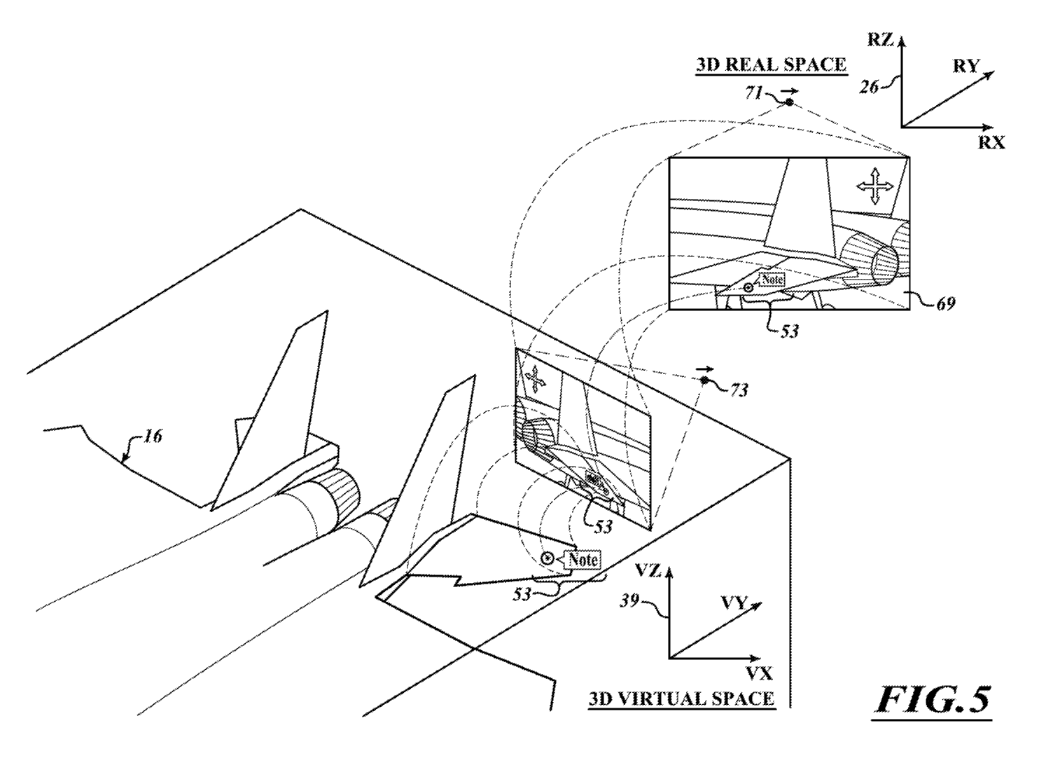

In step 40, the processor 13/13′ projects the annotated 2D image/video 69 to surfaces of the 3D model 16 in the 3D virtual space 39, to thereby create an annotated 3D model, as additionally illustrated in FIG. 5. The annotated 2D image/video 69 is associated with the 3D coordinate and orientation of the visual sensor 18 used to acquire the annotated 2D image/video 69, which are shown as a combination 71 of a dot (3D coordinate) and a vector (orientation) of the visual sensor 18 in FIG. 5. The step of projecting the annotated 2D image/video 69, taken in the 3D real space 26, to surfaces of the 3D model 16, in the 3D virtual space 39, entails translating the 3D coordinate and orientation 71 of the visual sensor 18 in the 3D real space 26 to the corresponding 3D coordinate and orientation 73 of the visual sensor 18 in the 3D virtual space 39. The translation calculation is based on the merging of the 3D virtual space 39 and the 3D real space 26 that was completed in step 36 above. At the 3D coordinate and orientation 73 in the 3D virtual space 39, the visual sensor 18 essentially “sees” the annotated 2D image/video 69 aligned and registered with the 3D model 16. Therefore, the annotated 2D image/video 69, in particular the annotation 53 added thereto, can be projected onto the 3D model 16 using any suitable 2D to 3D projection techniques capable of mapping two-dimensional points to a three-dimensional surface, such as a line-tracing technique or any texture projection techniques. As a result, an annotated 3D model 75 is created (see FIGS. 1 and 2), which is the 3D model 16 with the annotation 53 added to the 3D model 16. For example, the inspector's hand-drawn outlining of the damage 55 found on the tail wing of the airplane (22) as well as the inspector's note regarding the damage 55 are now associated with a portion of the 3D model 16 that precisely corresponds to the location of the damage 55 found in the 3D real space 26.

As used herein, surfaces of the 3D model 16 are not limited to external surfaces and may include internal surfaces of the 3D model 16. For example, one of the advantages of a volume-based 3D model is that it can represent an internal structure of a real object that is not visible from outside with naked eyes, such as an internal component within an airplane or an organ in a human body. According to various embodiments of the present invention, the annotated 2D image/video 69 can be projected to an internal surface of the 3D model 16. For example, the annotation 53 on the damage 55 found on the tail wing of the airplane (22) may be projected onto an internal part that underlies the tail wing so that the inspector can assess any impact the damage 55 may cause on the internal part.

In step 42, optionally, the annotated 3D model 75 thus created may be displayed on the display 30. In various embodiments, it is useful for the operator 47 to visually confirm the annotation 53 now added to the 3D model 16 on the display 30. To that end, as shown in FIG. 1, the processor 13/13′ sends the annotated 3D model 75 to the display 30, again via a suitable wireless communication link 67 for example, so that the operator 47 can verify the annotated 3D model 75 online, in real time, and on-site. The operator 47 may edit the annotation 53, which is now part of the 3D model 16, on the display 30. For example, the operator 47 may add, delete, change electronic ink, marker and note, etc., which was added as an annotation to the 3D model 16, while viewing the annotated 3D model 75 on the display 30.

In step 44, the annotated 3D model 75 is stored in the storage device 14/14′, for example as part of a maintenance log for the real object 22.

The above description focuses on the configuration that includes the tablet computer 11 and the separate server 12 communicating with each other online, in real time, wherein the separate server 12 is further communicating online, in real time, with the observer 28 of the laser tracking system. In other embodiments, all of the functions necessary to create an annotated 3D model may be performed or controlled by the tablet computer 11, such that the tablet computer 11 can be used as a stand-alone, real-time, mobile device to create an annotated 3D model. For example, where the 3D model 16 is loaded to the storage device 14′ of the tablet computer 11 and the processor 13′ of the tablet computer 11 is capable of carrying out various computation and calculation needed in steps 36, 38, and 40 described above, the tablet computer 11 need not communicate with the separate server 12 for creating an annotated 3D model. Still further, while the tablet computer 11 including the laser probe 20′ may be used as an almost stand-alone device that communicates with the observer 28 of the laser tracking device to obtain various 3D coordinates information, if a stand-alone position/orientation tracker 20 capable of determining its 3D position is included in the tablet computer 11, the tablet computer 11 becomes a truly stand-alone device.

The AR annotation computer system 10, which is suited for online (real time) mobile application of the present invention to create an annotated 3D model, has been described. Various advantages of the present AR annotation computer system 10 are apparent from the foregoing description. First, an operator/inspector may add an annotation directly to a 2D image/video of a real object, which is automatically projected onto its 3D model. Thus, the operator need not manually note the type (visual characteristics) and location of any damage/defect found on a real object, nor enter them manually as an annotation to a 3D model. Accordingly, the process of keeping a maintenance log for a real object is substantially streamlined. Second, the operator can reduce the number of physical contacts that he/she has to make with a real object to the number of real alignment points required to achieve merging between the 3D virtual space and the 3D real space. If the real alignment points are placed relative to the real object and not directly on the real object, then the number of required physical contacts with the real object is reduced to zero. This is a significant improvement over the current method, which often requires the operator to make a physical contact with a damaged area of a real object. Third, because an annotation is added directly to a 2D image/video of a real object, which is precisely aligned and projected onto its 3D model, the annotation is highly accurate and precise. Specifically, a high-resolution camera may be used as the visual sensor 18 to capture a 2D image/video of a real object, which can be magnified on the display 30 having a zoom-in feature. Therefore, the operator can add an annotation to the 2D image/video accurately and precisely, wherein the resolution of the annotation can be as high as the resolution of the 2D image/video obtainable with the visual sensor 18.

Still further advantages of the present invention are that some of the steps described above may be carried out offline, off time, and off-site, such that the process of creating an annotated 3D model can be arranged in various forms, with some or all of the steps divided amongst different operators (or even robots), performed at different times, and at different locations, as will be described below.

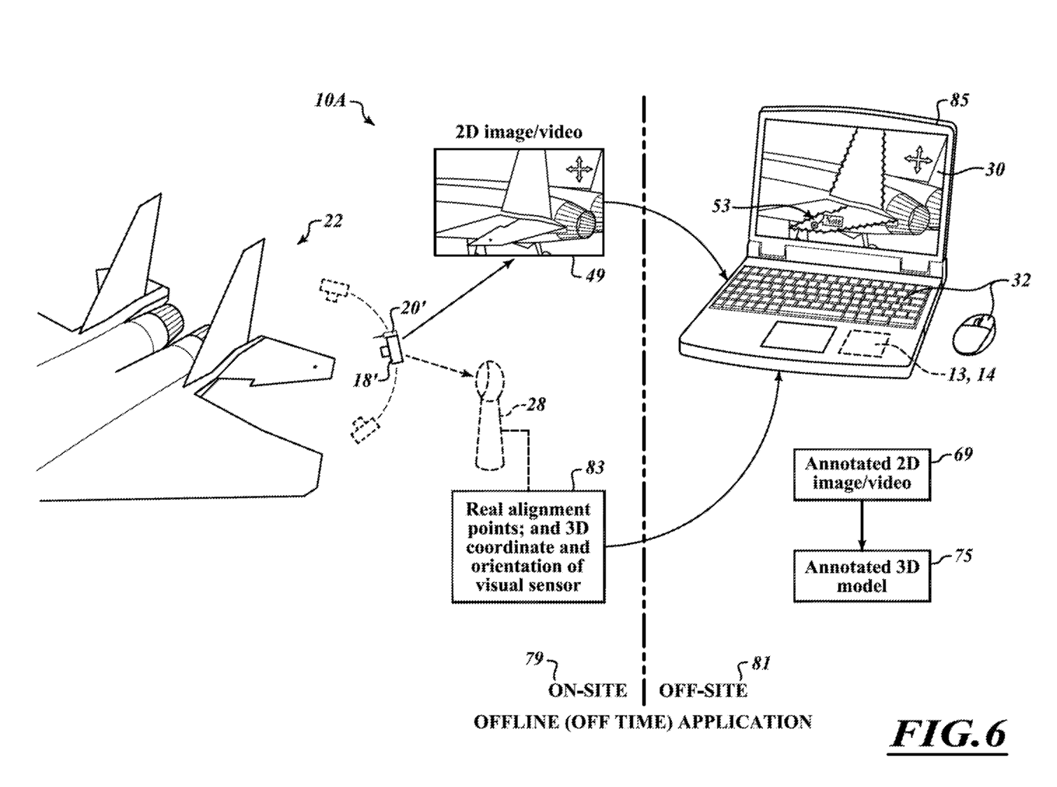

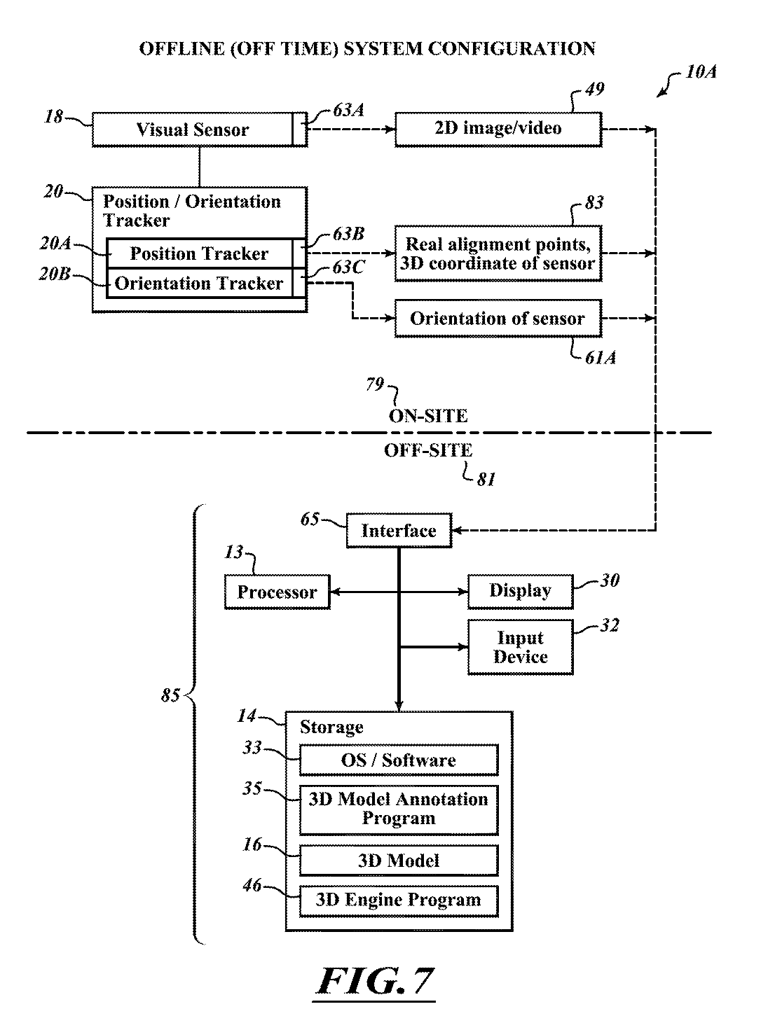

FIG. 6 is a diagram showing an AR annotation computer system 10A, which is suitable for offline (off time) application of the present invention to create an annotated 3D model, according to one embodiment. Referring additionally to FIG. 7, which shows example components included in the AR annotation computer system 10A of this embodiment, only the visual sensor 18 and the position/orientation tracker 20 need to be present on-site 79 where the real object 22 exists, and the rest of the AR annotation computer system 10A may be located off-site 81 and offline, i.e., not communicable in real time with the visual sensor 18 and the position/orientation tracker 20. In the illustrated embodiment, a camera or a camcorder 18′ is used as the visual sensor 18, and the laser probe 20′ of the laser tracking system including the observer 28 is used as the position/orientation tracker 20. In the offline (off time) application, annotation and analysis of the 2D image/video 49 captured by the visual sensor 18 may be conducted offline, off-site 81, and at a later time (off time), by another operator. In some embodiments, acquisition of the 2D image/video 49 in association with the 3D coordinate and orientation of the visual sensor 18 used to acquire the 2D image/video 49 may be conducted automatically by a robot, on-site 79. Still further, the process may be divided to be performed in three time periods: a first time period in which the 2D image/video 49 and the associated 3D coordinate and orientation of the visual sensor 18 used to acquire the 2D image/video are captured; a second time period in which an operator adds an annotation to the 2D image/video 49 to create an annotated 2D image/video 69, and a third time period in which a processor is used to merge the 3D virtual space with the 3D real space and to project the annotated 2D image/video 69 to surfaces of the 3D model 16 in the 3D virtual space 39.

As shown in FIG. 7, the on-site components that need to be located on-site 79 include the visual sensor 18 configured to acquire the 2D image/video 49 of the real object 22, the position tracker 20A configured to acquire the 3D coordinates 83 of at least two real alignment points (see FIG. 4) and of the visual sensor 18 used to acquire the 2D image/video 49, and the orientation tracker 20B operable to acquire the orientation 61A of the visual sensor 18 used to acquire the 2D image/video 49. Data collected by the visual sensor 18 and the position/orientation tracker 20, which includes integral or separate position tracker 20A and orientation tracker 20B, on-site 79, are transferred to the rest of the AR annotation computer system 10A placed off-site 81. The components that may be placed off-site 81 may be part of an off-site computer 85 such as a notebook computer, as shown in FIG. 6. The off-site computer 85 includes the processor 13, the storage device 14, the display 30, the input device 32 in the form of a keyboard and a mouse, and an interface 65 for inputting and outputting various data to and from the off-site computer 85. As shown in FIG. 7, the storage device 14 is loaded with an OS for controlling operation of the processor 13 as well as any software to be run by the processor 13. The storage device 14 also includes the 3D model annotation program 35 configured to perform various steps for creating an annotated 3D model according to embodiments of the present invention, the 3D model 16, and the 3D engine program 46, all of which are described above in connection with the AR annotation computer system 10 of FIG. 1.

For the purpose of transferring data collected by the visual sensor 18 and the position/orientation tracker 20, on-site 79, to the off-site computer 85, the visual sensor 18 and the position/orientation tracker 20, which includes integral or separate position tracker 20A and orientation tracker 20B, respectively include interface components 63A, 63B, and 63C, to prepare and output data to a corresponding interface 65 provided on the off-site computer 85. The interface connection(s) between the on-site components and the off-site components may be a wireless communication link according to any suitable communications standards such as the Wi-Fi standards, 3GPP 3G/4G/LTE standards, and the Bluetooth® standards, though it need not be wireless because the embodiment of the AR annotation computer system 10A is suited for offline (off time) application. For example, the visual sensor 18 and the position/orientation tracker 20, which includes integral or separate position tracker 20A and orientation tracker 20B, may be coupled via a wired connection to the interface 65 of the off-site computer 85, for example, after data acquisition by these on-site components has been completed (i.e., off time). As another example, the visual sensor 18 and the position/orientation tracker 20, which includes integral or separate position tracker 20A and orientation tracker 20B, may be physically transported from on-site 79 to off-site 81 and their respective interface components 63A, 63B, and 63C plugged into the interface 65 of the off-site computer 85, to transfer the data to the off-site computer 85.

In the offline (off time) application of the present invention, as shown in FIG. 6, an operator present off-site 81 may add an annotation 53 to the 2D image/video 49 of the real object 22, which was acquired on-site 79, perhaps by another operator (or by a robot) at another time. The processor 13 of the off-site computer 85 then creates the annotated 3D model 75 by projecting the annotated 2D image/video 69, created off-site 81 by the operator at the off-site computer 85, to the 3D model 16 stored in the off-site computer 85. In various related embodiments, some or all of the steps required for creating an annotated 3D model can be divided amongst different operators (or even robots), performed at different times, and at different locations, depending on needs specific to each application. For example, an on-site robot may be used to acquire a 2D video of a real object so as to capture as much information as possible about the real object (more information than a 2D image), which may then be analyzed off-site by an experienced operator/reviewer.

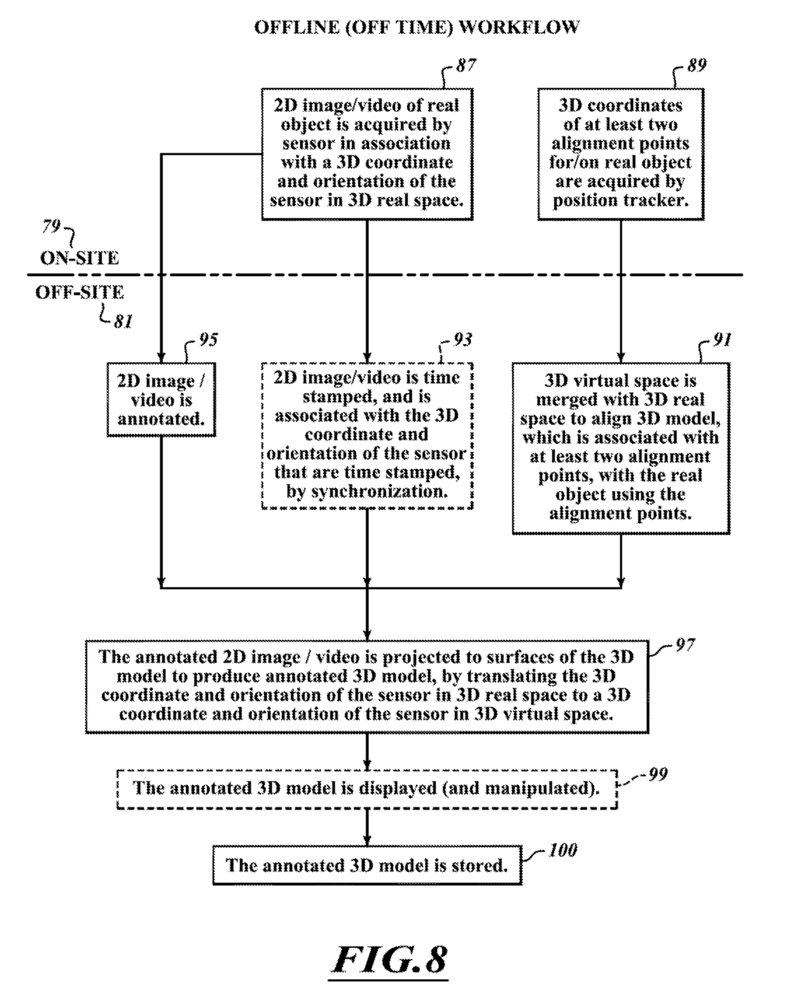

FIG. 8 is a flowchart illustrating an example process of creating an annotated 3D model in the offline (off time) application of the present invention according to one embodiment. Steps 87 and 89 occur on-site 79, while the rest of the steps 91, 93, 95, 97, 99 and 100 may all occur off-site 81. As shown, steps 87 and 89 may occur in any order or even simultaneously with each other. Similarly, steps 91, 93 and 95 may occur in any order or even simultaneously with each other. The only requirement is that steps 91, 93 (if performed), and 95 need to be performed before proceeding to step 97.

In step 87, a 2D image/video of a real object 22 is acquired by a visual sensor 18, in association with a 3D coordinate and orientation of the visual sensor 18 used to acquire the 2D image/video. As before, the association may be based on time stamps applied to each of the 2D image/video, the 3D coordinate of the visual sensor 18, and the orientation of the visual sensor 18, which may thereafter be used to synchronize (correlate) the 2D image/video with the 3D coordinate and orientation of the visual sensor 18 (step 93). Alternatively, a direct association between the 2D image/video and the 3D coordinate and orientation of the visual sensor 18 may be established on-site 79.

In step 89, 3D coordinates of at least two real alignment points for/or the real object 22 are acquired using a suitable position tracker 20A.

In step 91, the 3D virtual space 39, in which the 3D model 16 exists, is merged with the 3D real space 26, in which the real object 22 exists, by matching at least two virtual alignment points associated with the 3D model 16 with the at least two real alignment points acquired in step 89 above. (See FIG. 4.)

In step 95, the 2D image/video of the real object acquired in step 87 above is annotated, to thereby create an annotated 2D image/video 69.

In step 97, the annotated 2D image/video 69 prepared in step 95 above is projected to surfaces of the 3D model 16 in the 3D virtual space 39, to thereby generate an annotated 3D model 75, by translating the 3D coordinate and orientation of the visual sensor 18 in the 3D real space 26 to a 3D coordinate and orientation of the visual sensor 18 in the 3D virtual space 39. (See FIG. 5).

In step 99, optionally, the annotated 3D model created in step 97 above may be displayed on the display 30 of the off-site computer 85 for the operator to view, verify, and edit using the input device 32 the annotated 3D model on the display 30.

In step 100, the annotated 3D model is stored in a storage device accessible by the processor. The annotated 3D model 75 may thereafter be freely edited, updated, and may also be compared with an older version of the annotated 3D model, for example, to assess the effectiveness of any corrective measures applied to a damage/defect, as reflected in the updated version of the annotated 3D model, relative to the damage/defect as originally found and recorded in the older version of the annotated 3D model.

The various embodiments described above can be combined to provide further embodiments. As will be apparent to those skilled in the art, while the above description used examples of aircraft and maintenance, various embodiments of the present invention are equally applicable in other implementations and in other fields, such as in manufacturing field, medical field, entertainment field, military field, gaming field, etc. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An augmented reality (AR) annotation computer system, comprising:
a processor;
a storage device loaded with a 3D model of a real object and accessible by the processor, the 3D model being associated with at least two virtual alignment points;
a visual sensor connected to a position/orientation tracker and to an orientation tracker, the visual sensor being provided to acquire an image/video of the real object in 3D real space while the position/orientation tracker acquires a 3D coordinate and orientation of the visual sensor in the 3D real space; and
a display connected to an input device, which are configured to allow an operator to add an annotation to the image/video of the real object acquired by the visual sensor, to thereby create an annotated 2D image/video;
wherein the storage device is further loaded with an operating system and a 3D model annotation program, the 3D model annotation program being configured to cause the processor to perform steps comprising:
receiving 3D coordinates of at least two real alignment points for/on the real object;
merging 3D virtual space, in which the 3D model exists, with the 3D real space, in which the real object exists, to thereby align the 3D model with the real object, by matching the at least two virtual alignment points of the 3D model with the at least two real alignment points of the real object;
projecting the annotated 2D image/video of the real object to surfaces of the 3D model by translating the 3D coordinate and orientation of the visual sensor in the 3D real space used to acquire the annotated 2D image/video to the 3D coordinate and orientation of the visual sensor in the 3D virtual space, to thereby create an annotated 3D model; and
storing the annotated 3D model in the storage device.

2. The AR annotation computer system of claim 1, which is a portable tablet computer system.

3. The AR annotation computer system of claim 1, wherein the visual sensor connected to the position/orientation tracker, and the display connected to the input device, are included in a portable tablet computer, while the processor and the storage device are included in a separate server.

4. The AR annotation computer system of claim 1, wherein the position/orientation tracker is a probe of a laser tracking system.

5. A computer-readable tangible medium including computer-executable instructions of a 3D model annotation program which, when executed by a processor coupled to a storage device loaded with a 3D model of a real object, the 3D model being associated with at least two virtual alignment points, causes the processor to perform steps comprising:
receiving 3D coordinates of at least two real alignment points for/on the real object;
merging 3D virtual space, in which the 3D model exists, with 3D real space, in which the real object exists, to thereby align the 3D model with the real object, by matching the at least two virtual alignment points of the 3D model with the at least two real alignment points of the real object;
projecting an annotated 2D image/video of the real object to surfaces of the 3D model by translating a 3D coordinate and orientation of a visual sensor in the 3D real space used to acquire the annotated 2D image/video to a 3D coordinate and orientation of the visual sensor in the 3D virtual space, to thereby create an annotated 3D model; and
storing the annotated 3D model in the storage device.

6. The computer-readable tangible medium including computer-executable instructions of the 3D model annotation program of claim 5, which causes the processor to perform the further step of:
displaying the annotated 3D model on a display coupled to the processor.

7. The computer-readable tangible medium including computer-executable instructions of the 3D model annotation program of claim 5, which causes the processor to perform the further step of:
receiving an edit to an annotation associated with the annotated 3D model.

8. The computer-readable tangible medium including computer-executable instructions of the 3D model annotation program of claim 5, wherein the step of translating the 3D coordinate and orientation of the visual sensor in the 3D real space used to acquire the annotated 2D image/video to the 3D coordinate and orientation of the visual sensor in the 3D virtual space includes sub-steps comprising: (i) receiving a first time stamp associated with the annotated 2D image/video; (ii) receiving a second time stamp associated with the 3D coordinate of the visual sensor in the 3D real space; (iii) receiving a third time stamp associated with the orientation of the visual sensor in the 3D real space; and (iv) associating the annotated 2D image/video with the 3D coordinate and orientation of the visual sensor by synchronization based on the first, second and third time stamps.

9. The computer-readable tangible medium including computer-executable instructions of the 3D model annotation program of claim 5, wherein the 3D model is one of a point-based 3D model, surface-based 3D model, volume-based 3D model, and digital sculpting-based 3D model.

10. The computer-readable tangible medium including computer-executable instructions of the 3D model annotation program of claim 5, wherein the 3D model is a volume-based 3D model and the step of projecting the annotated 2D image/video to surfaces of the 3D model includes projecting the annotated 2D image/video to an internal surface of the 3D model.

11. The computer-readable tangible medium including computer-executable instructions of the 3D model annotation program of claim 5, which causes the processor to perform the further step of:
receiving a 2D image/video of the real object; and
receiving an annotation to the 2D image/video of the real object to generate the annotated 2D image/video of the real object.

12. The computer-readable tangible medium including computer-executable instructions of the 3D model annotation program of claim 5, which causes the processor to perform the further step of:
receiving the annotated 2D image/video of the real object.

13. The computer-readable tangible medium including computer-executable instructions of the 3D model annotation program of claim 5, which causes the processor to perform the further step of:
comparing an updated annotated 3D model with the annotated 3D model stored in the storage device.

14. A method of creating an annotated 3D model of a real object, comprising:
(i) loading a 3D model of the real object to a processor-accessible storage device, the 3D model being associated with at least two virtual alignment points;
(ii) acquiring 3D coordinates of at least two real alignment points for/on the real object in 3D real space using a position tracker;
(iii) acquiring an image/video of the real object in the 3D real space using a visual sensor and acquiring a 3D coordinate and orientation of the visual sensor used to acquire the image/video in the 3D real space;
(iv) adding an annotation to the image/video of the real object, to thereby create an annotated 2D image/video;
(v) using a processor to merge 3D virtual space, in which the 3D model exists, with the 3D real space, in which the real object exists, to thereby align the 3D model with the real object, by matching the at least two virtual alignment points of the 3D model with the at least two real alignment points of the real object;
(vi) using the processor to project the annotated image/video of the real object to surfaces of the 3D model by translating the 3D coordinate and orientation of the visual sensor in the 3D real space used to acquire the annotated 2D image/video to a 3D coordinate and orientation of the visual sensor in the 3D virtual space, to thereby create an annotated 3D model; and
(vii) storing the annotated 3D model in the storage device.

15. The method of creating an annotated 3D model of a real object according to claim 14, wherein an operator performs steps (iii), (iv), (v) and (vi) in real time at a location where the real object exists.

16. The method of creating an annotated 3D model of a real object according to claim 14, wherein a first operator performs steps (ii) and (iii) at a first location where the real object exists, and a second operator performs steps (iv), (v), (vi) and (vii) at a second location.

17. The method of creating an annotated 3D model of a real object according to claim 14, wherein steps (ii) and (iii) are performed at a first point in time, and steps (iv), (v), (vi) and (vii) are performed at a second point in time.

18. The method of creating an annotated 3D model of a real object according to claim 14, wherein steps (ii) and (iii) are performed at a first point in time, step (iv) is performed at a second point in time, and steps (v), (vi) and (vii) are performed at a third point in time.

19. The method of creating an annotated 3D model of a real object according to claim 14, wherein step (iv) of adding an annotation to the image/video of the real object includes firstly enlarging the image/video of the real object and secondly adding an annotation to the enlarged image/video of the real object.

20. The method of creating an annotated 3D model of a real object according to claim 14, further comprising:
(viii) comparing an updated annotated 3D model of the real object with the annotated 3D model previously recorded in the storage device.
